(19) United States
(12) Patent Application Publication
(10) Pub. No.: US 2022/0327265 A1
(43) Pub. Date: Oct. 13, 2022

(54) IN-SITU STRESS EVALUATION METHOD BASED ON WELLBORE MECHANICAL INSTABILITY COLLAPSE

(71) Applicant: Southwest Petroleum University, Chengdu (CN)

(72) Inventors: Lixi LIANG, Chengdu (CN); Xiangjun LIU, Chengdu (CN); Jian XIONG, Chengdu (CN); Yi DING, Chengdu (CN); Wen ZHANG, Chengdu (CN); Kepei HE, Chengdu (CN)

(21) Appl. No.: 17/848,567

(22) Filed: Jun. 24, 2022

Related U.S. Application Data
(63) Continuation of application No. PCT/CN2021/125957, filed on Oct. 25, 2021.

(30) Foreign Application Priority Data
Mar. 17, 2021 (CN) 202110285745.7

(51) Int. Cl. G06F 30/28

(52) U.S. Cl. CPC G06F 30/28; G06F 2119/14

(57) ABSTRACT

Disclosed is an in-situ stress evaluation method based on a wellbore mechanical instability collapse, including: selecting a mechanical instability collapse wellbore section and classifying a data, obtaining a deep in-situ stress according to a structural strain coefficient, establishing a structural strain coefficient equation based on a wellbore stress critical equilibrium condition, obtaining the structural strain coefficient by using a least squares method and obtaining a horizontal principal stress, and estimating a reasonableness of the deep in-situ stress. The method selects data of the wellbore mechanical instability collapse and classify the data to establish a stress critical equilibrium equation based on a strain coefficient and solve an overdetermined equation based on a critical collapse formation information restriction, so as to obtain a maximum horizontal principal stress and a minimum horizontal principal stress.

### CROSS-REFERENCE TO RELATED APPLICATIONS

This application is a continuation of International Patent Application No. PCT/CN2021/125957, filed on Oct. 25, 2021, which claims the benefit of priority from Chinese Patent Application No. 202110285745.7, filed on Mar. 17, 2021. The content of the aforementioned applications, including any intervening amendments thereto, is incorporated herein by reference in its entirety.

### TECHNICAL FIELD

The present application relates to geomechanics, oil-gas well engineering and oil and gas extraction technology, and more particularly to an in-situ stress evaluation method based on wellbore mechanical instability collapse.

### BACKGROUND

In-situ stress is a fundamental parameter for the design and implementation of deep underground engineering, especially in oil and gas drilling. Evaluation of deep in-situ stress is extremely important for borehole trajectory design, wellbore stability evaluation, well optimization, fracture stimulation, prediction of sand production and safe mining operation. At present, deep in-situ stress is evaluated mainly by drilling core stress test, stress analysis of mine data such as fracturing and drilling and in-situ stress profile logging calculation.

The traditional method requires calibration and constraint of stress from stress tests or mine data analysis to ensure a reliability of a logging in-situ stress calculation results. For large-scale stimulation, a method of analyzing in-situ stress by hydraulic fracturing data is difficult to satisfy needs of the evaluation of in-situ stress because of many factors affecting the data. Wellbore collapse and drilling induced fracture are another important information that can be used to evaluate the deep in-situ stress, but are mainly limited to the evaluation of deep in-situ stress. Mark D. Zoback proposed a theoretical model to calculate the in-situ stress based on borehole collapse. Whereas, due to non-homogeneity of deep formation rocks, irregularity of actual wellbore collapse, and unavailability of wellbore collapse related parameters, the theoretical model is still difficult to be effectively and practically applied to the calculation and evaluation of the deep in-situ stress. Therefore, this application provides an in-situ stress evaluation method based on wellbore mechanical instability collapse to overcome the existing problems.

### SUMMARY

Accordingly, an object of the present disclosure is to provide an in-situ stress evaluation method based on wellbore mechanical instability collapse. The method selects data of the wellbore mechanical instability collapse and classify the data to establish a stress critical equilibrium equation based on a strain coefficient and solve an overdetermined equation based on a critical collapse formation information restriction, so as to obtain a maximum horizontal principal stress and a minimum horizontal principal stress, thus provides a evaluation method for reasonableness of in-situ stress and a quantitative calculation and evaluation of the deep principal in-situ stress. It provides a basic parameters of deep formation mechanics necessary for deep underground engineering, especially oil-gas well engineering, oil and gas extraction engineering, etc.

Technical solutions of the disclosure are described as follows.

An in-situ stress evaluation method based on wellbore mechanical instability collapse, comprising:

(S1) selecting a wellbore section having a gentle stratigraphical structure based on a geological research result; and calculating a wellbore enlargement ratio based on caliper logging data as according to the following equation:

$${CER}_{i} = \frac{{CAL}_{i} - {BIT}_{i}}{{BIT}_{i}} \times 100 \qquad ( 1 )$$

wherein CERᵢ is a wellbore enlargement ratio of a depth point of an i^{th} formation of the wellbore section; CALᵢ is a caliper of the i^{th} formation; and BITᵢ is a bit size for the i^{th} formation;

selecting a formation data point in which the wellbore mechanical instability collapse is distributed within ±15° of a minimum horizontal principal stress; and

classifying a depth formation data based on an obtained data and the wellbore enlargement ratio;

(S2) obtaining a deep in-situ horizontal in-situ stress according to a structural strain coefficient (ε_{H1},εₕ₂), expressed as:

$${σ}_{V} = {\int }_{0}^{DEP} Den ( dep ) {d}_{dep} \qquad ( 2 )$$

$${σ}_{H 1} ( {ε}_{H 1} , {ε}_{h 2} ) = \frac{μ}{1 - μ} {σ}_{V} + \frac{E {ε}_{H 1}}{1 - {μ}^{2}} + \frac{E {με}_{h 2}}{1 - {μ}^{2}} \qquad ( 3 )$$

$${σ}_{h 2} ( {ε}_{H 1} , {ε}_{h 2} ) = \frac{μ}{1 - μ} {σ}_{V} + \frac{E {με}_{H 1}}{1 - {μ}^{2}} + \frac{E {ε}_{h 2}}{1 - {μ}^{2}} ; \qquad ( 4 )$$

and

in a cylindrical coordinate system, without considering a seepage effect of formation around a well, expressing a wellbore stress in terms of the structural strain coefficient (ε_{H1},εₕ₂) when a well round angle of the wellbore is 90° or 270°, expressed as:

$${σ}_{z} = {\int }_{0}^{DEP} Den ( dep ) {d}_{dep} + 2 μ ( \frac{E {ε}_{H 1}}{1 + μ} - \frac{E {ε}_{h 2}}{1 + μ} ) \qquad ( 5 )$$

$${σ}_{θ} ( {ε}_{H 1} , {ε}_{h 2} ) = \frac{2 μ}{1 - μ} {σ}_{V} + \frac{E {ε}_{H 1} ( 3 - μ )}{1 - {μ}^{2}} - \frac{E {ε}_{h 2} ( 1 - 3 μ )}{1 - {μ}^{2}} - {aP}_{w} \qquad ( 6 )$$

$${σ}_{r} ( {ε}_{H 1} , {ε}_{h 2} ) = {P}_{w} ; \qquad ( 7 )$$

(S3) establishing a structural strain coefficient equation based on a wellbore stress critical equilibrium condition; selecting a strength criterion of rock for determining a bottom collapse; inputting equations (5), (6) and (7) to the strength criterion to build a superdeterministic equation set of the structural strain coefficient (ε_{H1},εₕ₂), expressed as:

Fᵢ(ε_{H1},εₕ₂)=0 (8)

wherein the function Fᵢ(ε_{H1},εₕ₂) is determined by the strength criterion;

(S4) obtaining, by using a least squares method, a maximum horizontal structural strain coefficient and a minimum horizontal structural strain coefficient of the wellbore section to input to the equations (3) and (4), so as to obtain a maximum horizontal principal stress and the minimum horizontal principal stress of the wellbore section; and

(S5) inputting the maximum horizontal structural strain coefficient, the minimum horizontal structural strain coefficient and a corresponding parameter of a classified formation to equation (8) to obtain the Fᵢ; subjecting the Fᵢ to two types of computational discriminant; if none of the computational discriminant is met, reselecting a wellbore section of the wellbore and then proceeding to steps (S2)-(S5) until the two types of computational discriminant are met.

In some embodiments, in the step (S1), during selecting, a formation having high clay content such as mudstone and shale is removed; and a structural plane developing formation such as fracture, stratification and joint and a formation having a relatively fragmentized structure are removed according to a result of log interpretation of shaliness to prevent a hydration of the formation having high clay content and a wellbore collapse formation dominated by a structural plane.

In some embodiments, in the step (S1), the depth formation data is classified to: a S-type formation data, wherein a wellbore is stable, 0<CERᵢ≤3%, an enlargement of a wellbore section is not obvious and a caliper of the wellbore section is regular; an A-type formation data, wherein a wellbore is in critical equilibrium and 3%<CERᵢ≤7%; and a B-type formation data, wherein a wellbore is in collapse, CERᵢ>7% and an enlargement of a wellbore section is obvious.

In some embodiments, in the step (S2), the ε_{H1},εₕ₂ of equations (2), (3) and (4) are the maximum horizontal structural strain coefficient and the minimum horizontal structural strain coefficient, respectively; DEP is a depth; Den is a formation density; E is an elastic modulus of formation; μ is a Poisson ratio; σ_{V} is a vertical principal stress; σ_{H1}(ε_{H1},εₕ₂) is the maximum horizontal principal stress when the structural strain coefficient is ε_{H1}; and σₕ₂(ε_{H1},εₕ₂) is the minimum horizontal principal stress when the structural strain coefficient is εₕ₂.

In some embodiments, D_{mud} of equations (5), (6) and (7) is a drilling fluid density; P_{w} is a drilling fluid column pressure; and P_{w}=∫₀^{DEP} D_{mud}(deP)d_{dep}.

In some embodiments, in the step (S3), the strength criterion of rock is selected from Mohr-Coulomb criterion, Drucker-Prager criterion and Hoek-Brown criterion according to a mechanical property of formation and deformation characteristic to estimate a horizontal in-situ stress.

In some embodiments, in the step (S5) the two types of computational discriminant comprise a first computational discriminant and a second computational discriminant;

in the first computational discriminant, for a wellbore section of which an enlargement is obvious, a B-type formation data not involved in calculation is input to equation (8) to discriminate whether Fᵢ(ε_{H1},εₕ₂)>0; and

in the second computational discriminant, for a wellbore section of which a caliper is regular and a wall is stable, a S-type formation data not involved in calculation is input to equation (8) to discriminate whether Fᵢ(ε_{H1},εₕ₂)<0.

In some embodiments, if the first computational discriminant and the second computational discriminant are both met, a result of the structural strain coefficient and a result of an in-situ stress estimation are reasonable.

This application has the following beneficial effects.

By means of selecting and classifying the data of the wellbore mechanical instability collapse, the stress critical equilibrium equation based on the strain coefficient is built and the overdetermined equation based on a critical collapse formation information restriction is solved, so as to obtain a maximum horizontal principal stress and a minimum horizontal principal stress. As a result, an in-situ stress evaluation method and a quantitative calculation and evaluation of the deep principal in-situ stress are obtained, which provide a basic parameters of deep formation mechanics necessary for deep underground engineering, especially oil-gas well engineering, oil and gas extraction engineering, etc.

### BRIEF DESCRIPTION OF THE DRAWINGS

FIG. 1 is a flow chart of an in-situ stress evaluation method based on wellbore mechanical instability collapse of the present disclosure;

FIG. 2 shows a caliper of a selected wellbore section and rock mechanics relevant parameters of the selected wellbore section according to an embodiment of the present disclosure;

FIG. 3 shows a formation data of a removed formation having high clay content according to an embodiment of the present disclosure;

FIG. 4 shows results of estimation of in-situ stress at each depth point according to an embodiment of the present disclosure; and

FIG. 5 shows results of computational discriminant of Fᵢ according to an embodiment of the present disclosure.

### DETAILED DESCRIPTION OF EMBODIMENTS

The disclosure will be clearly and completely described below with reference to the accompanying drawings and embodiments, and it should be understood that these embodiments are illustrative and are not intended to limit the disclosure.

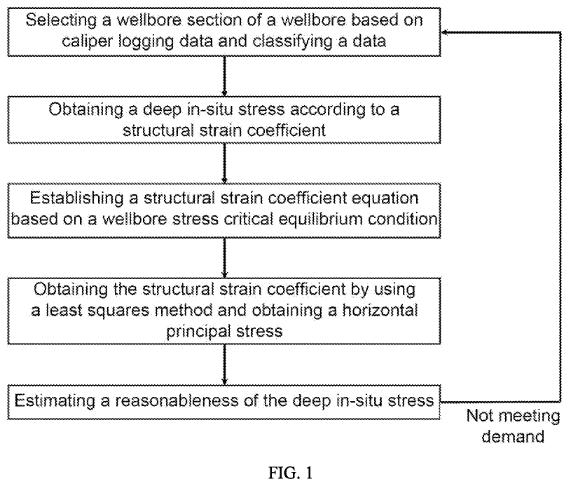

Referring to FIGS. 1-5, an in-situ stress evaluation method based on wellbore mechanical instability collapse is provided, which is specifically described as follows.

(S1) A wellbore section of a wellbore having a relatively gentle stratigraphical structure based on a geological research result is selected. A wellbore enlargement ratio based on caliper logging data is calculated as according to the following equation:

$${CER}_{i} = \frac{{CAL}_{i} - {BIT}_{i}}{{BIT}_{i}} \times 100 \qquad ( 1 )$$

where CERᵢ is a wellbore enlargement ratio of a depth point of an i^{th} formation of the wellbore section; CALᵢ is a caliper of the i^{th} formation; and BITᵢ is a bit size for the i^{th} formation.

A formation data point is selected, in which the wellbore mechanical instability collapse is distributed within ±15° of a minimum horizontal principal stress. A depth formation data is classified based on an obtained data and the wellbore enlargement ratio.

The depth formation data is classified into three types.

(1) A S-type formation data of which a wellbore is stable, where 0<CERᵢ≤3%, an enlargement of the wellbore section is not obvious and the caliper of the wellbore section is regular.

(2) An A-type formation data of which the wellbore is in critical equilibrium, where 3%<CERᵢ≤7%.

(3) A B-type formation data of which the wellbore is in collapse, where CERᵢ>7% and the enlargement of the wellbore section is obvious.

A formation data with a depth span of no more than 15 m in the A-type formation data is selected to be subjected to steps (S2)-(S5).

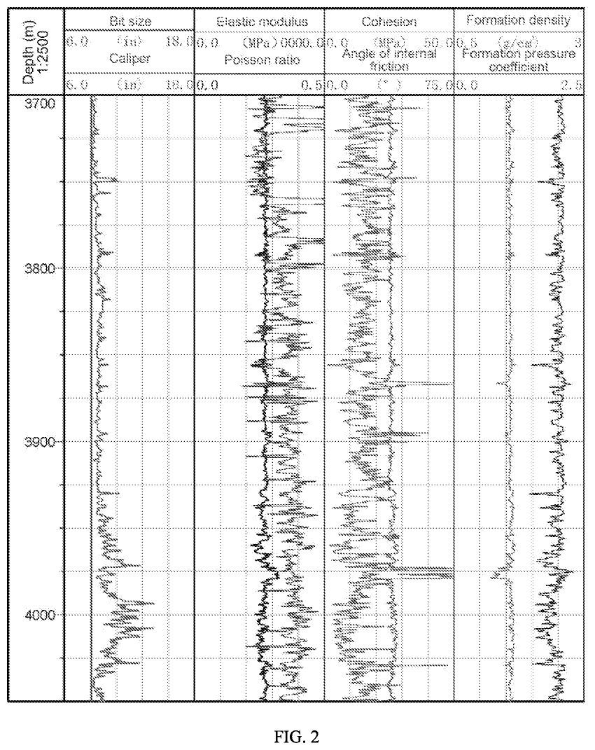

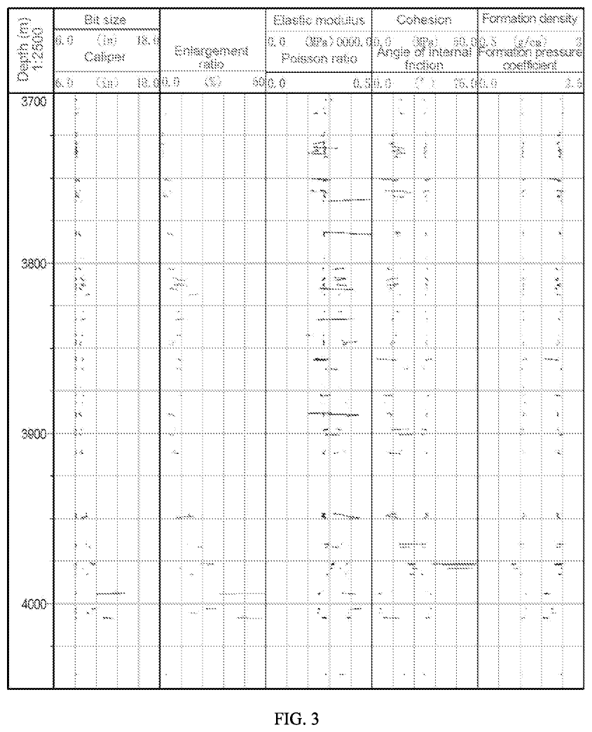

The wellbore section having a relatively gentle stratigraphical structure which is selected is shown in FIG. 2. A wellbore section shown in FIG. 3 is subjected to selecting a formation and calculation of an enlargement ratio according to steps (S2) and (S3), results are shown in FIG. 3. The formation is classified to three types according to the enlargement ratio. The A-type formation data is selected and analyzed according to the above-mentioned method, and the results are shown in Table 1.

TABLE 1
Data for analysis (A-type formation data)

| | Enlargement | | Elasticity | | Angle of | | Pore |
|---|---|---|---|---|---|---|---|
| | ratio | Density | modulus | Poisson | internal | Cohesion | pressure |
| Depth | (%) | (g/cm3) | (MPa) | ratio | friction (°) | (MPa) | coefficient |
| 3748.000 | 3.2288% | 2.5208 | 27913.67 | 0.2732 | 38.2762 | 12.2886 | 1.0732 |
| 3750.375 | 5.1806% | 2.1914 | 21850.09 | 0.2461 | 42.0137 | 3.4153 | 1.1409 |
| 3751.250 | 3.2233% | 2.3958 | 28033.71 | 0.2768 | 38.2469 | 10.7749 | 1.0629 |
| 3753.375 | 4.0704% | 2.3899 | 28174.68 | 0.2745 | 38.6061 | 9.8995 | 1.0708 |

During selecting, a formation having high clay content such as mudstone and shale is removed; and a structural plane developing formation such as fracture, stratification and joint and a formation having a relatively fragmentized structure are removed according to a result of log interpretation of shaliness to prevent a hydration of the formation having high clay content and a wellbore collapse formation dominated by a structural plane.

(S2) A deep in-situ horizontal in-situ stress is obtained according to a structural strain coefficient (ε_{H1},εₕ₂), expressed as follows.

$${σ}_{V} = {\int }_{0}^{DEP} Den ( dep ) {d}_{dep} \qquad ( 2 )$$

$${σ}_{H 1} ( {ε}_{H 1} , {ε}_{h 2} ) = \frac{μ}{1 - μ} {σ}_{V} + \frac{E {ε}_{H 1}}{1 - {μ}^{2}} + \frac{E {με}_{h 2}}{1 - {μ}^{2}} \qquad ( 3 )$$

$${σ}_{h 2} ( {ε}_{H 1} , {ε}_{h 2} ) = \frac{μ}{1 - μ} {σ}_{V} + \frac{E {με}_{H 1}}{1 - {μ}^{2}} + \frac{E {ε}_{h 2}}{1 - {μ}^{2}} \qquad ( 4 )$$

The ε_{H1},εₕ₂ of equations (2), (3) and (4) are a maximum horizontal structural strain coefficient and a minimum horizontal structural strain coefficient, respectively. DEP is depth. Den is formation density. E is elastic modulus of formation. μ is poisson ratio. σ_{V} is vertical principal stress. σ_{H1}(ε_{H1},εₕ₂) is a maximum horizontal principal stress when the structural strain coefficient is ε_{H1}·σₕ₂(ε_{H1},εₕ₂) is a minimum horizontal principal stress when the structural strain coefficient is εₕ₂.

In a cylindrical coordinate system, without considering a seepage effect of formation around a well, a wellbore stress is expressed in terms of the structural strain coefficient (ε_{H1},εₕ₂) when a well round angle of the wellbore is 90° or 270°, expressed as follows.

$${σ}_{z} = {\int }_{0}^{DEP} Den ( dep ) {d}_{dep} + 2 μ ( \frac{E {ε}_{H 1}}{1 + μ} - \frac{E {ε}_{h 2}}{1 + μ} ) \qquad ( 5 )$$

$${σ}_{θ} ( {ε}_{H 1} , {ε}_{h 2} ) = \frac{2 μ}{1 - μ} {σ}_{V} + \frac{E {ε}_{H 1} ( 3 - μ )}{1 - {μ}^{2}} - \frac{E {ε}_{h 2} ( 1 - 3 μ )}{1 - {μ}^{2}} - {aP}_{w} \qquad ( 6 )$$

$${σ}_{r} ( {ε}_{H 1} , {ε}_{h 2} ) = {P}_{w} \qquad ( 7 )$$

D_{mud} of equations (5), (6) and (7) is a drilling fluid density; P_{w} is a drilling fluid column pressure; and P_{w}=∫₀^{DEP} D_{mud}(dep)d_{dep}.

(S3) A structural strain coefficient equation is established based on a wellbore stress critical equilibrium condition. A strength criterion of rock is selected for determining a bottom collapse. The strength criterion of rock is selected from Mohr-Coulomb criterion, Drucker-Prager criterion and Hoek-Brown criterion according to a mechanical property of formation and deformation characteristic to estimate a horizontal in-situ stress. equations (5), (6) and (7) are input to the strength criterion to build a superdeterministic equation set of the structural strain coefficient (ε_{H1},εₕ₂), expressed as:

Fᵢ(ε_{H1},εₕ₂)=0 (8)

where the function Fᵢ(ε_{H1},εₕ₂) is determined by the strength criterion.

If the Mohr-Coulomb criterion is selected, the superdeterministic equation set of the structural strain coefficient (ε_{H1},εₕ₂) is expressed as:

$${F}_{i} ( {ε}_{H 1} , {ε}_{h 2} ) = {m}_{i} {ε}_{H 1} + {n}_{i} {ε}_{h 2} - {A}_{i} = 0 \qquad ( 9 )$$

$$where {m}_{i} = \frac{( 3 - {μ}_{i} ) {E}_{i}}{1 - {μ}_{i}^{2}} , {n}_{i} = \frac{( 3 {μ}_{i} - 1 ) {E}_{i}}{1 - {μ}_{i}^{2}} ,$$

$${A}_{i} = {Dep}_{i} ( 1 + {c tan}^{2} ( \frac{π}{4} - {φ}_{i} ) ) {D}_{mudi} {/}_{100} + 2 {C}_{i} c tan ( \frac{π}{4} - {φ}_{i} )$$

$$and - {a}_{i} {P}_{pi} ( {c tan}^{2} ( \frac{π}{4} - {φ}_{i} ) - 1 ) - \frac{2 {μ}_{i}}{1 - {μ}_{i}} {σ}_{Vi} .$$

Depᵢ is a depth of a depth point of an i^{th} formation of the wellbore section. Eᵢ is an elastic modulus of the depth point of the i^{th} formation. μᵢ is a poisson ratio of the depth point of the i^{th} formation. aᵢ is a Biot's coefficient of the depth point of the i^{th} formation. Cᵢ is a cohesion of the depth point of the i^{th} formation. φᵢ is an angle of internal friction of the depth point of the i^{th} formation. σ_{Vi} is a vertical principal stress of the depth point of the i^{th} formation. Pₚᵢ is a pore pressure coefficient of the depth point of the i^{th} formation. D_{mud}_{ⁱ} is a drilling fluid density where the drilling fluid is used to drill at the depth point of the i^{th} formation.

(S4) By using a least squares method, a maximum horizontal structural strain coefficient and a minimum horizontal structural strain coefficient of the wellbore section are obtained to input to the equations (3) and (4), so as to obtain the maximum horizontal principal stress and the minimum horizontal principal stress of the wellbore section.

equation (9) is expressed in a matrix as equation (10):

$$\vert \begin{matrix}{m}_{1} & {n}_{1} \\ {m}_{2} & {n}_{2} \\ … & … \\ {m}_{i} & {n}_{i} \\ … & … \\ {m}_{K} & {n}_{K}\end{matrix} \vert \vert \begin{matrix}{ε}_{H 1} \\ {ε}_{h 2}\end{matrix} \vert = \vert \begin{matrix}{A}_{1} \\ {A}_{2} \\ … \\ {A}_{i} \\ … \\ {A}_{K}\end{matrix} \vert \qquad ( 10 )$$

When K≥2, the maximum horizontal structural strain coefficient ε_{H1} and the minimum horizontal structural strain coefficient εₕ₂ can both be obtained. When K>2, equation (10) is a binary hyperdeterministic equation set, which usually subjected to an operation expressed as equation (11) to obtain the maximum horizontal structural strain coefficient ε_{H1} and the minimum horizontal structural strain coefficient εₕ₂.

$$\vert \begin{matrix}{m}_{1} & {m}_{2} & … & {m}_{i} & … & {m}_{K} \\ {n}_{1} & {n}_{2} & … & {n}_{i} & … & {n}_{K}\end{matrix} \vert \vert \begin{matrix}{m}_{1} & {n}_{1} \\ {m}_{2} & {n}_{2} \\ … & … \\ {m}_{i} & {n}_{i} \\ … & … \\ {m}_{K} & {n}_{K}\end{matrix} \vert \vert \begin{matrix}{ε}_{H 1} \\ {ε}_{h 2}\end{matrix} \vert = \vert \begin{matrix}{m}_{1} & {m}_{2} & … & {m}_{i} & … & {m}_{K} \\ {n}_{1} & {n}_{2} & … & {n}_{i} & … & {n}_{K}\end{matrix} \vert \vert \begin{matrix}{A}_{1} \\ {A}_{2} \\ … \\ {A}_{i} \\ … \\ {A}_{K}\end{matrix} \vert \qquad ( 11 )$$

A maximum horizontal structural strain coefficient ε_{H1}* and a minimum horizontal structural strain coefficient εₕ₂* both obtained above are input to equations (3) and (4) to obtain the maximum horizontal principal stress and the minimum horizontal principal stress.

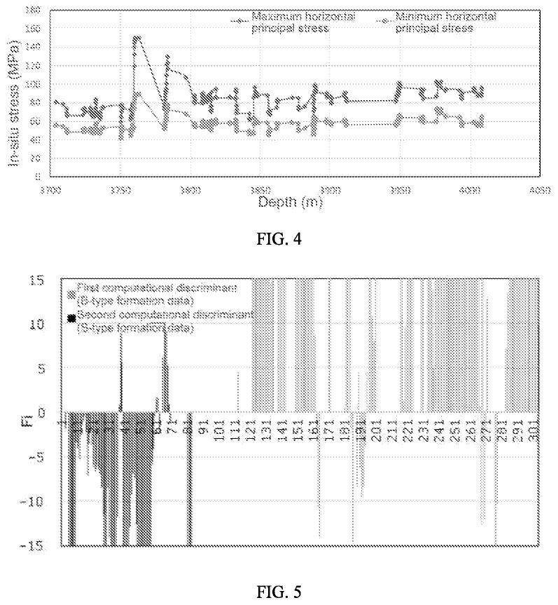

By means of the above-mentioned steps, the maximum horizontal structural strain coefficient ε_{H1}* is 1.31413×10⁻³ and the minimum horizontal structural strain coefficient εₕ₂* is 0.30406×10⁻³. The maximum horizontal structural strain coefficient and the minimum horizontal structural strain coefficient are input to equations (3) and (4) to obtain the maximum horizontal principal stress and the minimum horizontal principal stress, results are shown in FIG. 4.

(S5) The maximum horizontal structural strain coefficient ε_{H1}*, the minimum horizontal structural strain coefficient εₕ₂* and a corresponding parameter of an A-type formation are input to equation (8) or (9) to obtain the Fᵢ to be subjected to computational discriminant, expressed as follows.

A first computational discriminant is performed as follows. For a wellbore section of which an enlargement is obvious, the B-type formation data not involved in calculation is input to equation (8) or (9) to discriminate whether Fᵢ(ε_{H1},εₕ₂)>0.

A second computational discriminant is performed as follows. For a wellbore section of which a caliper is regular and a wall is stable, the S-type formation data not involved in calculation is input to equation (8) or (9) to discriminate whether Fᵢ(ε_{H1},εₕ₂)<0.

If the first computational discriminant and the second computational discriminant are both met, a result of the structural strain coefficient and a result of an in-situ stress estimation are reasonable.

If most of results fail to meet the first computational discriminant or the second computational discriminant, the result of the in-situ stress estimation is not reasonable. A wellbore section of the wellbore is re-selected to proceed to steps (S2)-(S5) until the first computational discriminant and the second computational discriminant are met, i.e., the result of the in-situ stress estimation is reasonable.

Based on the computational discriminant of the Fᵢ, results of the first computational discriminant and the second computational discriminant are shown in FIG. 5. Except some data points, most results of the data point of the first computational discriminant are greater than 0 and that of the second computational discriminant is less than 0, thus the result of the in-situ stress estimation is reasonable.

The in-situ stress evaluation method based on wellbore mechanical instability collapse selects data of the wellbore mechanical instability collapse and classify the data to establish a stress critical equilibrium equation based on a strain coefficient and solve an overdetermined equation based on a critical collapse formation information restriction, so as to obtain a maximum horizontal principal stress and a minimum horizontal principal stress, thus provides a method for evaluating reasonableness of in-situ stress and a quantitative calculation and evaluation of the deep principal in-situ stress. It provides a basic parameters of deep formation mechanics necessary for deep underground engineering, especially oil-gas well engineering, oil and gas extraction engineering, etc.

Described above are only some embodiments of the present disclosure, which are not intended to limit the disclosure. It should be understood that any variations and improvements made by those of ordinary skilled in the art without departing from the spirit of the disclosure shall fall within the scope of the disclosure defined by the appended claims.

What is claimed is:

1. An in-situ stress evaluation method based on wellbore mechanical instability collapse, comprising:
(S1) selecting a wellbore section having a gentle stratigraphical structure based on a geological research result; and calculating a wellbore enlargement ratio based on caliper logging data as according to the following equation:
$${CER}_{i} = \frac{{CAL}_{i} - {BIT}_{i}}{{BIT}_{i}} \times 100 \qquad ( 1 )$$
wherein CERᵢ is a wellbore enlargement ratio of a depth point of an i^{th} formation of the wellbore section; CALᵢ is a caliper of the i^{th} formation; and BITᵢ is a bit size for the i^{th} formation;
selecting a formation data point in which the wellbore mechanical instability collapse is distributed within ±15° of a minimum horizontal principal stress; and
classifying a depth formation data based on an obtained data and the wellbore enlargement ratio;
(S2) obtaining a deep in-situ horizontal in-situ stress according to a structural strain coefficient (ε_{H1},εₕ₂), expressed as:
$${σ}_{V} = {\int }_{0}^{DEP} Den ( dep ) {d}_{dep} \qquad ( 2 )$$
$${σ}_{H 1} ( {ε}_{H 1} , {ε}_{h 2} ) = \frac{μ}{1 - μ} {σ}_{V} + \frac{E {ε}_{H 1}}{1 - {μ}^{2}} + \frac{E {με}_{h 2}}{1 - {μ}^{2}} \qquad ( 3 )$$
$${σ}_{h 2} ( {ε}_{H 1} , {ε}_{h 2} ) = \frac{μ}{1 - μ} {σ}_{V} + \frac{E {με}_{H 1}}{1 - {μ}^{2}} + \frac{E {ε}_{h 2}}{1 - {μ}^{2}} \qquad ( 4 )$$
wherein the ε_{H1} is a maximum horizontal structural strain coefficient; the εₕ₂ is a minimum horizontal structural strain coefficient; DEP is a depth of formation; Den(dep) is a formation density of a formation of which a depth is dep; E is an elastic modulus of formation; μ is a Poisson ratio; σ_{V} is a vertical principal stress; σ_{H1}(ε_{H1},εₕ₂) is a maximum horizontal principal stress when the structural strain coefficient is ε_{H1}; and σₕ₂(ε_{H1},εₕ₂) is the minimum horizontal principal stress when the structural strain coefficient is εₕ₂; and
in a cylindrical coordinate system, without considering a seepage effect of formation around a well, expressing a wellbore stress in terms of the structural strain coefficient (ε_{H1},εₕ₂) when a well round angle of the wellbore is 90° or 270°, expressed as:
$${σ}_{z} = {\int }_{0}^{DEP} Den ( dep ) {d}_{dep} + 2 μ ( \frac{E {ε}_{H 1}}{1 + μ} - \frac{E {ε}_{h 2}}{1 + μ} ) \qquad ( 5 )$$
$${σ}_{θ} ( {ε}_{H 1} , {ε}_{h 2} ) = \frac{2 μ}{1 - μ} {σ}_{V} + \frac{E {ε}_{H 1} ( 3 - μ )}{1 - {μ}^{2}} - \frac{E {ε}_{h 2} ( 1 - 3 μ )}{1 - {μ}^{2}} - {aP}_{w} \qquad ( 6 )$$
$${σ}_{r} ( {ε}_{H 1} , {ε}_{h 2} ) = {P}_{w} ; \qquad ( 7 )$$
(S3) establishing a structural strain coefficient equation based on a wellbore stress critical equilibrium condition; selecting a strength criterion of rock for determining a bottom collapse; inputting equations (5), (6) and (7) to the strength criterion to build a superdeterministic equation set of the structural strain coefficient (ε_{H1},εₕ₂), expressed as:
Fᵢ(ε_{H1},εₕ₂)=0 (8)
wherein the function Fᵢ(ε_{H1},εₕ₂) is determined by a selected strength criterion;
(S4) obtaining, by using a least squares method, the maximum horizontal structural strain coefficient and the minimum horizontal structural strain coefficient of the wellbore section to input to the equations (3) and (4), so as to obtain the maximum horizontal principal stress and the minimum horizontal principal stress of the wellbore section; and
(S5) inputting the maximum horizontal structural strain coefficient, the minimum horizontal structural strain coefficient and a corresponding parameter of a classified formation to equation (8) to obtain the Fᵢ; subjecting the Fᵢ to two types of computational discriminant; if none of the computational discriminant is met, reselecting a wellbore section of the wellbore and then proceeding to steps (S2)-(S5) until the two types of computational discriminant are both met.

2. The in-situ stress evaluation method of claim 1, wherein in the step (S1), during selecting a wellbore section, a formation having high clay content such as mudstone and shale is removed; and a structural plane developing formation such as fracture, stratification and joint and a formation having a fragmentized structure are removed according to a result of log interpretation of shaliness to prevent a hydration of the formation having high clay content and a wellbore collapse formation dominated by a structural plane.

3. The in-situ stress evaluation method of claim 1, wherein in the step (S1), the depth formation data is classified to: a S-type formation data, wherein a wellbore is stable, 0<CERᵢ≤3%, an enlargement of a wellbore section is not obvious and a caliper of the wellbore section is regular; an A-type formation data, wherein a wellbore is in critical equilibrium and 3%<CERᵢ≤7%; and a B-type formation data, wherein a wellbore is in collapse, CERᵢ>7% and an enlargement of a wellbore section is obvious.

4. The in-situ stress evaluation method of claim 1, wherein in the step (S2), the P_{w}=∫₀^{DEP} D_{mud}(dep)d_{dep}; and D_{mud} is a drilling fluid density.

5. The in-situ stress evaluation method of claim 1, wherein in the step (S3), the strength criterion of rock is selected from Mohr-Coulomb criterion, Drucker-Prager criterion and Hoek-Brown criterion according to a mechanical property of formation and a deformation characteristic to estimate a horizontal in-situ stress.

6. The in-situ stress evaluation method of claim 1, wherein in the step (S5), the two types of computational discriminant comprise a first computational discriminant and a second computational discriminant;
in the first computational discriminant, for a wellbore section of which an enlargement is obvious, a B-type formation data not involved in calculation is input to equation (8) to determine whether Fᵢ(ε_{H1},εₕ₂)>0; and
in the second computational discriminant, for a wellbore section of which a caliper is regular and a wall is stable, a S-type formation data not involved in calculation is input to equation (8) to determine whether Fᵢ(ε_{H1},εₕ₂)<0.

7. The in-situ stress evaluation method of claim 6, wherein if the first computational discriminant and the second computational discriminant are both met, a result of the structural strain coefficient and a result of an in-situ stress estimation are reasonable.
